(19) United States
(12) Patent Application Publication
(10) Pub. No.: US 2012/0094192 A1
(43) Pub. Date: Apr. 19, 2012

(54) COMPOSITE NANOWIRE COMPOSITIONS AND METHODS OF SYNTHESIS

(75) Inventors: Jun Qu, Oak Ridge, TN (US); Sheng Dai, Knoxville, TN (US)

(73) Assignee: UT-BATTELLE, LLC, Oak Ridge, TN (US)

(21) Appl. No.: 12/904,559

(22) Filed: Oct. 14, 2010

(51) Int. Cl. H01M 10/056; H01M 10/058; B05D 5/12; H01B 5/14; H01M 4/58; B82Y 99/00

(52) U.S. Cl. 429/336; 174/126.2; 429/218.1; 429/231.5; 216/13; 427/58; 977/762

(57) ABSTRACT

Nanowire array compositions in which nanowires containing at least one Group IV metal (e.g., Si or Ge) in a single layer or core-shell nanowire structure, wherein, in particular embodiments, the nanowires have a transition metal core and/or are surrounded by or embedded within a metal oxide or metal oxide-ionic liquid ordered host material. The nanowire compositions are incorporated into the anodes of lithium ion batteries. Methods of preparing the nanowire compositions, particularly by low temperature methods, are also described.

This invention was made with government support under Contract Number DE-AC05-00OR22725 between the United States Department of Energy and UT-Battelle, LLC. The U.S. government has certain rights in this invention.

### FIELD OF THE INVENTION

The present invention relates, generally, to core-shell nanowire compositions, as well as materials useful as anodes for lithium ion batteries.

### BACKGROUND OF THE INVENTION

Current lithium-ion battery capacity (as used in, for example, electric vehicles) is mainly limited by the low theoretical capacity (372 mAh/g) of the graphite anode. Among known anode materials, silicon (Si) has the highest theoretical capacity i.e., 4,200 mAh/g, which is more than ten times higher than that of graphite. However, silicon experiences a very large volume expansion (up to 400%) upon insertion of Li⁺ during charging, with each silicon atom alloying with an average of 4.4 Li atoms. The significant stresses, thus generated, make silicon anodes vulnerable to pulverization, leading to capacity fade during cycling. Therefore, silicon in bulk or film form cannot be practically used despite various attempts, such as by use of porous silicon.

Silicon nanowires have previously been reported to accommodate the large strain from Li⁺ insertion without pulverization. However, silicon nanowires have high electrical resistance due to their high aspect ratio and small contact area with the current collector, thus leading to inefficient charge transport (i.e., slow charging rate and power release). Moreover, the silicon nanowires currently known in the art generally possess the significant drawbacks of being randomly oriented, interlocked, and melded (i.e., overall non-uniform and non-aligned), all of which result in wire distortions, stress concentrations, and eventually, wire fracture and loss of capacity, when the nanowires swell upon Li⁺ insertion.

Furthermore, the very small interface area between the nanowire and substrate in silicon nanowires of the art causes shear stress due to silicon expansion as well as bending/tensile stresses due to the wire interlocks and attachment. These stresses often lead to separation of the nanowires from the current collector, which is believed to be one of the major causes for the significant capacity loss.

Moreover, the techniques used thus far for the synthesis of silicon nanowires are significantly energy intensive, such as by requiring high vacuum and/or high temperature conditions. Some common examples of such techniques of the art include vapor-liquid-solid (VLS), pulsed-laser deposition (PLD), and chemical vapor deposition (CVD).

### SUMMARY OF THE INVENTION

In one aspect, the invention is directed to arrays of nanowires that possess a greater charge transport efficiency and resistance to wire distortions, stresses, and wire fractures than nanowires of the art. Thus, the nanowires of the invention generally exhibit a greater resistance to capacity loss (i.e., better capacity retention on cycling) than nanowires of the art.

In a first embodiment, the invention is directed to an array of nanowires, wherein the nanowires contain a transition metal core surrounded by a shell containing at least one Group IV metal selected from silicon, germanium, and tin, herein also referred to as “(transition metal core)-(Group IV metal shell) nanowires”. Preferably, the array of nanowires possesses a significant degree of spatial ordering and/or uniformity in alignment and/or thickness. The nanowires in the array are also preferably not in contact with each other. The shell generally provides high capacity while the core functions as the built-in current collector and provides mechanical support and toughness. The core-shell nanowire structure allows very short (nm) transport paths for both the Li-ions and electrons, and a low contact resistance between the shell and core due to the large contact area. These characteristics provide fast charging and power release. The core is preferably directly rooted to the current collector (usually made of a transition metal as well), and thus, can maintain a high-efficiency charge transport path. The aligned structure naturally avoids the interlocking-induced bending/tensile stresses typically encountered during battery operation. The core-shell structure is generally more capable of maintaining capacity even when cracks occur in the shell material. Such cracks are generally inevitable due to material flaws and the significant volume change in charge-discharge cycles. Cracks will either stop at the core-shell interface or need to travel a significant distance (e.g., micrometers) to cause spallation. The shell may crack into segments, but the capacity can be retained as long as those segments are still connected to the core.

In a second embodiment, the invention is directed to an array of nanowires, wherein the nanowires include (i.e., as a minimum set of features, or alternatively, composed solely of) at least one Group IV metal selected from silicon, germanium, and tin, wherein the nanowires are surrounded by a metal oxide shell. A space separates the nanowire and metal oxide shell in order to prevent the nanowire from contacting the metal oxide shell. At least one significant advantage of employing a space between the nanowire and metal oxide shell is that, when the array of nanowires is used in the anode of a lithium-ion battery, the space allows battery electrolyte to flow therethrough, thereby creating a more efficient battery system. The space can also, for example, advantageously accommodate an expansion of the Group IV metal core (particularly, silicon) during cycling of a lithium-ion battery.

In a third embodiment, the invention is directed to an array of Group IV metal nanowires embedded within the pores (i.e., periodic nanochannels) of a nanoporous metal oxide-ionic liquid ordered host material. The resulting composition is a uniformly patterned composite material that contains nanowires containing at least one Group IV metal selected from silicon, germanium, and tin, embedded within periodic nanochannels of the nanoporous metal oxide-ionic liquid ordered host material. In the foregoing composition, the nanowires are advantageously uniformly separated and aligned within the ordered metal oxide-ionic liquid host material. The significantly small nanowire widths, along with their high degree of uniformity and alignment, results in nanowire arrays having a high theoretical capacity, fast charging, and increased power density.

In another aspect, the invention is directed to lithium-ion batteries that contain any of the nanowire array materials described above, particularly in the anode of the lithium-ion battery.

In other aspects, as further described below, the invention is directed to methods for producing the nanowire array compositions described above.

As an exemplary method for producing the nanowire array composition of the first embodiment described above, the method preferably includes the steps of: (i) depositing a transition metal into channels of a nanoporous template; (ii) removing the template to produce exposed transition metal nanowires; and (iii) depositing a metal that includes at least one Group IV metal selected from silicon, germanium, and tin, onto said transition metal nanowires to produce an array of (transition metal core)-(Group IV metal shell) nanowires. In particular embodiments, the nanoporous template is a track-etched polycarbonate (PC) or nanoporous anodic aluminum oxide (AAO) membrane.

In an alternative exemplary method for producing the nanowire array composition of the first embodiment described above, the method preferably includes the steps of: (i) depositing a coating of an etchable material into pores of a porous substrate provided that a nanochannel having a width remains in each coated pore; (ii) depositing a transition metal into the nanochannels to produce transition metal nanowires, wherein the transition metal nanowires have widths equivalent or substantially comparable to the nanochannel widths; (iii) removing the coating of etchable material to provide a spacing between each transition metal nanowire and inner walls of the pores of the porous substrate; and (iv) depositing a metal that includes at least one Group IV metal selected from silicon, germanium, and tin, into the spacings to produce an array of (transition metal core)-(Group IV metal shell) nanowires. The foregoing alternative method is particularly useful in providing nanowire arrays with improved uniformity in wire dimensions and alignment.

As a method for producing the nanowire array composition of the second embodiment described above, the method preferably includes the steps of: (i) depositing a coating of an etchable material into pores of a porous metal oxide substrate provided that a nanochannel having a width remains in each coated pore; (ii) depositing a metal that includes at least one Group IV metal selected from silicon, germanium, and tin into the nanochannels to produce Group IV metal nanowires, wherein the Group IV metal nanowires have widths equivalent to the nanochannel widths; and (iii) removing the coating of etchable material to provide a spacing between each Group IV metal nanowire and inner walls of the pores of the porous metal oxide substrate.

As a method for producing nanowire array composition of the third embodiment described above, the method preferably includes depositing a metal containing at least one Group IV metal selected from silicon, germanium, and tin, into periodic nanochannels of a metal oxide-ionic liquid ordered host material. In particular embodiments, the metal oxide is or includes a silicon oxide material. In other particular embodiments, the ionic liquid is a N,N-dialkylimidazolium ionic liquid. In other particular embodiments, the metal oxide is or includes a silicon oxide material and the ionic liquid is a N,N-dialkylimidazolium ionic liquid

The nanowire array compositions described herein can advantageously produce at least the same and higher theoretical capacities when employed in a lithium-ion battery (e.g., 1000-3000 mAh/g), depending on the core and shell compositions, the density of nanowires on the substrate, thicknesses of the nanowires, and numerous other features. Further advantages include a generally improved capacity retention on cycling, as well as maintaining or improving charging, power density, and physical integrity during cycling. The preparative methods described herein also possess numerous advantages including energy efficiency, low cost, scalability, adjustability, and environmental soundness.

### BRIEF DESCRIPTION OF THE DRAWINGS

FIG. 1. Schematic illustration (steps a-d) of a low-cost approach for synthesizing a composite material containing an array of (metal core)-(Group IV metal shell) nanowires.

FIG. 2. Schematic illustration (steps a-f) showing an alternative methodology for synthesizing a composite material containing an array of (metal core)-(Group IV metal shell) nanowires.

FIG. 3. Schematic illustration (steps a-f) showing a preferred methodology for synthesizing a composite material containing Group IV metal nanowires within metal oxide shells, wherein a space is included between the nanowires and metal oxide shells.

FIG. 4. Micrograph of a copper nanowire array synthesized by template-aided electrodeposition, the steps of which are depicted in the general schematic of FIG. 1.

FIG. 5. Cu—Si core-shell nanowire array produced by depositing (i.e., by PECVD) a silicon layer on the copper nanowires shown in FIG. 4.

FIG. 6. Raman spectrum of the Cu—Si core-shell nanowire array shown in FIG. 5.

FIG. 7. Charge and discharge capacity and Coulombic efficiency versus cycle number for a half-cell using the Cu—Si core-shell nanowire array shown in FIG. 5 electrode-cycled between 2-0.005 V at a series charge/discharge rates.

### DETAILED DESCRIPTION OF THE INVENTION

In one aspect, the invention is directed to arrays of nanowires useful as, for example, lithium ion battery anode materials. Typically, the array of nanowires is present on a substrate, which is typically a conducting substrate.

The nanowires generally have a thickness of no more than about 1000 nm. In different embodiments, the nanowires have a thickness of precisely, at least, up to, or less than 900 nm, 800 nm, 700 nm, 600 nm, 500 nm, 450 nm, 400 nm, 350 nm, 300 nm, 250 nm, 200 nm, 150 nm, 100 nm, 50 nm, 40 nm, 30 nm, 20 nm, 10 nm, or 5 nm, or a thickness within a range bounded by any two of the foregoing values. As used herein, the term “about” generally indicates within±0.5, 1, 2, 5, or 10% of the indicated value (for example, “about 50 nm” can mean 50 nm±2%, which indicates 50±1 nm or 49-51 nm).

In particular embodiments, the nanowires are highly uniform in thickness by possessing a variation in thickness of, at most, 2%, 1%, 0.5%, 0.2%, 0.1%, or essentially no variation in thickness. In other embodiments, each nanowire possesses a degree of uniformity in its thickness through its length. For example, in one embodiment, the nanowires may possess a substantial variation in thickness by being at least 5 or 10% thicker at the base than at the mid-portion or peak, while in another embodiment, the nanowires may possess a highly uniform thickness by having a deviation in thickness through their lengths of no more than 2%, 1%, 0.5%, 0.2%, or 0.1%. The uniformity in thickness described above can also be a uniformity in thickness of individual layers in a nanowire, such as a core-shell type of nanowire, as further described below. In other embodiments, the nanowires are highly uniform in their orientation (i.e., alignment), e.g., by being substantially perpendicular (i.e., at or about 90 degrees) with respect to a substrate surface, and/or by being substantially parallel (i.e., at or about 0 degrees, or less than ±10 or ±5 degrees from 0 degrees) with each other. In other embodiments, the nanowires are arranged with a uniform spacing separating each of the nanowires. In different embodiments, the spacing between nanowires can be, for example, precisely, at least, up to, or less than 2 μm, 1.5 μm, 1 μm, 900 nm, 800 nm, 700 nm, 600 nm, 550 nm, 500 nm, 450 nm, 400 nm, 350 nm, 300 nm, 250 nm, 200 nm, 150 nm, 100 nm, 50 nm, 40 nm, 30 nm, 20 nm, 10 nm, or 5 nm, or a spacing within a range bounded by any two of the foregoing values.

Nanowire-nanowire contact, as often occurs in nanowire arrays of the art, is detrimental for at least the reason that it causes a loss of electrolyte-accessible surface area, which reduces the charging rate. This issue also prevents using high-density wire arrays, thereby limiting the capacity per unit area. The uniform spacing and alignment found in the nanowire arrays of the invention advantageously prevents the nanowires from contacting each other. Furthermore, the nanowire arrays of the invention can thus achieve high densities, thereby maximizing capacity.

In particular embodiments, the nanowires contain (i.e., at least include, or are composed entirely of) at least one Group IV metal selected from silicon (Si), germanium (Ge), and/or tin (Sn). The Group IV metal is typically in the metallic state.

In one embodiment, the nanowires are made solely of silicon. The silicon can be any of the known forms of silicon, including crystalline, polycrystalline, or amorphous silicon. In other embodiments, the nanowires are made solely of, or include, germanium or tin, in any of their known forms. The Ge or Sn nanowires can be combined with any of the metals described above.

In other embodiments, the nanowires include silicon combined with one or more other metals. The metals are generally considered herein to be in their metallic states. The silicon and one or more other metals can be in combination either as a homogeneous composition (e.g., alloy), or alternatively, as a heterogeneous composition (e.g., layered, core-shell, or grained composition containing distinct regions). The one or more other metals can be, for example, any of the transition metals (i.e., elements of atomic number 21-30, 39-48, or 72-80), or a main group metal (e.g., aluminum, gallium, carbon, indium, germanium, or tin).

In particular embodiments, the nanowires possess a core-shell arrangement. As used herein, the term “core-shell arrangement” indicates, as understood in the art, an arrangement of layers in which an inner portion (i.e., “core”) of a first composition is covered (i.e., generally, substantially or completely surrounded) by an outer portion (i.e., “shell”) of a second composition. One or more intermediate layers may or may not be present between the core and shell.

In one set of embodiments, the core of the core-shell nanowire is composed completely of, or includes, one or more Group IV metals, and the shell is a metallic composition different from the core, such as a metallic composition that includes another Group IV metal, a transition metal, and/or main group metal, or a combination thereof. In another set of embodiments, the shell is composed completely of, or includes, one or more Group IV metals, and the core is a metallic composition different from the shell, such as a metallic composition that includes another Group IV metal, a transition metal, and/or a main group metal, or a combination thereof. Some particular transition metals considered as either the core or shell include iron (Fe), cobalt (Co), nickel (Ni), copper (Cu), zinc (Zn), ruthenium (Ru), rhodium (Rh), palladium (Pd), silver (Ag), cadmium (Cd), iridium (Ir), platinum (Pt), gold (Au), and combinations thereof. In more particular embodiments, the transition metal considered as either the core or shell is a Group VIIIB metal (i.e., an iron-group metal), or Group IXB metal (i.e., cobalt-group metal), or Group XB metal (i.e., nickel-group metal), or Group IB metal (i.e., copper-group metal), or Group IIB metal (i.e., zinc-group metal), or combination thereof. Some particular main group metals considered as either the core or shell include aluminum (Al), gallium (Ga), carbon (C), indium (In), and combinations thereof, as well as their combinations with any of the Group IV metals.

In particular embodiments, the nanowires possess a Group IV metal and at least one transition metal in a core-shell arrangement. In particular embodiments, the nanowires include a Group IB transition metal core and a Group IV metal shell. Some examples of such core-shell nanowires include those having a copper-silicon (i.e., Cu—Si), copper-germanium (i.e., Cu—Ge), copper-tin (i.e., Cu—Sn), silver-silicon (i.e., Ag—Si), silver-germanium (i.e., Ag—Ge), silver-tin (i.e., Ag—Sn), gold-silicon (i.e., Au—Si), gold-germanium (i.e., Au—Ge), or gold-tin (i.e., Au—Sn) core-shell arrangement. In some embodiments, the core includes a combination of two or more Group IB transition metals, or a combination of a Group IB transition metal and another type of metal (e.g., one or more transition or main group metals). The combination of core metals can be, for example, a layered arrangement or an alloy of the combination of metals. In other embodiments, the shell includes a combination of two or more Group IV metals, or a combination of a Group IV metal and another type of metal (e.g., one or more transition or main group metals). The combination of shell metals can be, for example, a layered arrangement or an alloy of the combination of metals. In other embodiments, the shell includes a combination of metals, as described above, and the shell also includes a combination of metals, as described above. In yet other embodiments, the foregoing core-shell nanowires include solely one metal in the core and solely one metal in the shell. In still other embodiments, the core-shell nanowires can be embedded within a solid matrix (e.g., a metal oxide or organic polymer matrix), while in other embodiments, the core-shell nanowires are not embedded in a solid matrix. When the core-shell nanowires are not embedded in a solid matrix, the nanowires can be said to be separated by “empty space”, which is herein considered to exclude a solid matrix, and may be, for example, a vacuum or a gas, such as air. In other embodiments, the nanowires may be in separated in space from each other and in contact with a liquid matrix, such as a battery electrolyte.

In some embodiments, the core and shell can both contain a Group IV metal, while in other embodiments, the core and shell do not both include a Group IV metal. In different embodiments, one or more of the Group IV metals are excluded from the core or the shell. In other embodiments, one or more Group IB metals are excluded from the core or the shell

In different embodiments, the core and shell of the core-shell nanowire independently possess thicknesses of precisely, at least, up to, or less than 1000 nm, 900 nm, 800 nm, 700 nm, 600 nm, 500 nm, 450 nm, 400 nm, 350 nm, 300 nm, 250 nm, 200 nm, 150 nm, 100 nm, 50 nm, 40 nm, 30 nm, 20 nm, 10 nm, or 5 nm, or a thickness within a range bounded by any two of the foregoing values. In particular embodiments, the core and shell of the nanowires have thicknesses independently selected from a thickness of up to 50 nm, 100 nm, 200 nm, 300 nm, 400 nm, or 500 nm. In some embodiments, the core is thicker than the shell. In other embodiments, the shell is thicker than the core. In other embodiments, the core and shell have the same, or about or substantially the same, thickness. In particular embodiments, the thickness of the core, shell, or both, of the core-shell nanowire has a degree of uniformity (e.g., substantially or highly uniform), as described above for nanowire thicknesses.

The nanowires described above can be produced by any suitable method. Some methods suitable for the production of nanowire arrays include ion sputtering, plasma-enhanced chemical vapor deposition (PECVD), silicon electrodeposition techniques, vapor-liquid-solid (VLS) process, pulsed laser deposition (PLD), molecular beam epitaxy (MBE), and atomic layer deposition techniques. Details of each of these methods can be found in the art.

Preferably, the nanowires are produced by a method that does not require a high temperature (e.g., at or above 500° C.) and/or high pressure and/or vacuum. More preferably, the method for producing the nanowires can be performed at or below a temperature of 400° C., 300° C., 200° C., 100° C., 70° C., or 50° C., or a temperature at about room temperature (i.e., at about 15, 20, 25, or 30° C.). Such lower temperatures are achievable by use of, for example, PECVD or electrodeposition methods.

In particular embodiments, nanowires are produced by one or more electrodeposition processes. A particular electrodeposition process considered herein employs a process in which a metal is electrolytically or electrolessly deposited into the pores (i.e., channels) of a porous material (i.e., porous substrate or template). Such a process is also referred to herein as a template-aided electrodeposition (TAE) process. The TAE process can be used to deposit any of a wide variety of metals, including, for example, the transition metals (e.g., Cu) and main group metals (e.g., Si and other Group IV metals). Particularly considered herein is a silicon electrodeposition process in which at least one Group IV metal precursor (e.g., SiCl₄) in an ionic liquid-based electrolyte is employed. See, for example, R. Al-Salman, et al., Phys. Chem. Chem. Phys., 10, 6233-6237 (2008). The ionic liquid being used as an electrolyte can be, for example, an imidazolium or pyrrolidinium type of ionic liquid, such as any of the 1,3-dialkylimidazolium and 1,1-dialkylpyrrolidinium ionic liquids known in the art. Typically, the silicon electrodeposition process is conducted under anhydrous and inert atmosphere conditions in order to prevent SiCl₄ or other reactive precursor from becoming oxidized. A particular advantage of using the silicon electrodeposition process described above is the large electrochemical window afforded by the ionic liquid, in contrast to water. The large electrochemical window permits the electrodeposition of amorphous silicon, which would otherwise not be possible by conventional (i.e., aqueous) electrodeposition methods due to hydrogen evolution from the competing electrolysis of water.

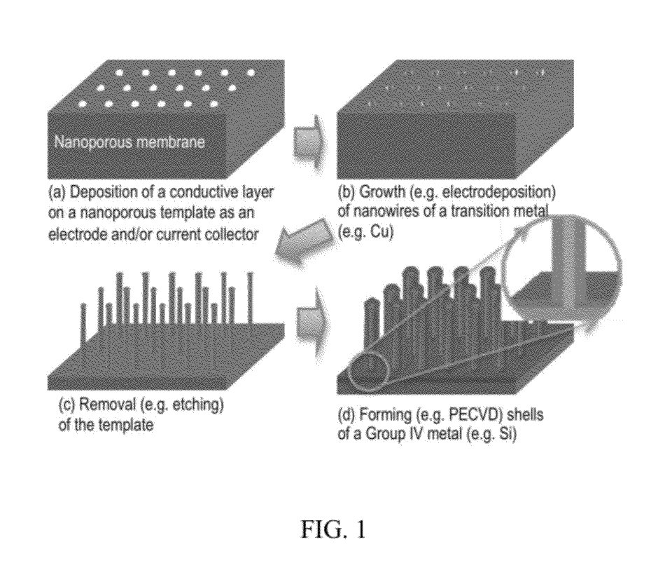

One exemplary process for producing (transition metal core)-(Group IV metal shell) nanowires is depicted in FIG. 1 (steps a-d). In the depicted process, a transition metal is electrodeposited into the pores of a nanoporous membrane to produce transition metal nanowires embedded in the nanoporous membrane (i.e., step shown in proceeding from step a to b in FIG. 1). The nanoporous membrane material is then removed, e.g., by dissolution or etching, to produce exposed transition metal nanowires, as depicted in proceeding from step b to c in FIG. 1. Finally, as depicted in step (d) of FIG. 1, one or more Group IV metals is deposited (for example, by PECVD) onto the transition metal nanowires, wherein the layer of Group IV metal is depicted with darker outlining in contrast to the lighter outlining used to depict the transition metal cores.

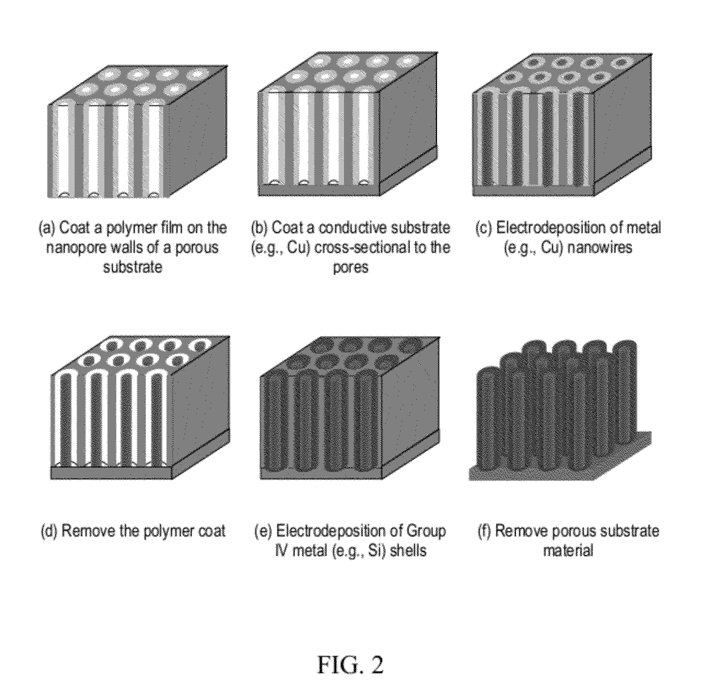

FIG. 2 (steps a-f) depicts an alternative exemplary process for producing (transition metal core)-(Group IV metal shell) nanowires. Referring to FIG. 2, an array of (transition metal core)-(Group IV metal shell) nanowires is produced by (i) depositing a coating of an etchable material (indicated by the lighter gray outlining in step (a)) onto the inner walls of the pores of a porous substrate, wherein, preferably, the coating of etchable material has a uniform thickness, provided that a nanochannel having a width remains in each coated pore (step (a) shown in FIG. 2). Step (i) is followed by (ii) depositing at least one transition metal into the produced nanochannels (e.g., by electrodeposition from an aqueous metal salt solution, such as a CuCl₂-containing aqueous electrolyte if Cu is desired to be deposited) to produce transition metal nanowires (depicted as darker gray outlining within pores) having a width equivalent to the nanochannel width (step (c) shown in FIG. 2). Generally, before producing the metal nanowires as described above, a cross-sectional substrate is coated on one side of the substrate to permit electrodeposition of metal into the pores, as shown in step (b) of FIG. 2. Step (ii) is followed by (iii) removing the coating of etchable material to provide a space (depicted as white outlining) between the resulting transition metal nanowires and inner pore walls of the porous material (step (d) shown in FIG. 2), and (iv) depositing at least one Group IV metal selected from Si, Ge, and Sn, into the spaces to produce an array of (transition metal core)-(Group IV metal shell) nanowires (step (e) shown in FIG. 2, wherein the layer of Group IV metal is depicted as darker outlining surrounding the transition metal nanowire.

In one embodiment, the porous substrate is not removed, i.e., the produced core-shell nanowires are embedded within the porous substrate (i.e., as produced in step (e) of FIG. 2) when they are used. In another embodiment, step (iv) is followed by removal of the porous substrate, thereby leaving a space between the core-shell nanowires (i.e., as shown in step (f) of FIG. 2). For the latter embodiment, it is preferred for the porous substrate to be an etchable substrate, as described above. In particular embodiments, the core-shell nanowire produced in this manner is a copper-silicon, silver-silicon, gold-silicon, nickel-silicon, palladium-silicon, platinum-silicon, or cobalt-silicon core-shell nanowire, as well as such core-shell nanowires in which silicon in any of the foregoing examples is replaced by or combined with germanium, and/or tin. In other embodiments, at least one Group IV metal is deposited into the channels while at least one transition metal is deposited in the spaces, thereby producing (Group IV metal core)-(transition metal shell) nanowires, such as silicon-copper or silicon-silver core-shell nanowires. An advantage of the foregoing methodology in producing core-shell nanowires is that the core and shell are generally highly uniform in thickness (from nanowire to nanowire), as well as in alignment and spacing between nanowires.

The etchable material can be any material that can be deposited into the pores of a porous substrate, is non-reactive with subsequently deposited metal, and that can be removed after metal has been deposited. The etchable polymer can be any polymer capable of being etched (e.g., by a solvent, such as methylene chloride) or otherwise removed by any suitable process (e.g., pyrolysis). The etchable material can be, for example, an organic material, such as an organic compound (e.g., wax) or organic polymer. The etchable polymer can be any polymer capable of being etched (e.g., by a solvent, such as methylene chloride) or otherwise removed by any suitable process (e.g., pyrolysis). Some examples of etchable polymers include the polyacrylates, polymethacrylates, polycarbonates, polyurethanes, fluoropolymers (e.g., polytetrafluoroethylene (PTFE)), polystyrenes, and polyesters, as well as copolymers thereof, and/or mixtures thereof.

The etchable material can be coated onto the pores by any suitable method, such as by melt wetting, as described in further detail in M. Steinhart, et al., Science, vol. 296, Jun. 14, 2002, the contents of which are incorporated herein in their entirety. Alternatively, the etchable material can be coated by solution wetting.

The coating of etchable material can have any suitable thickness, and more preferably, any of the thicknesses described above for the space separating the metal oxide shell and nanowire. However, the etchable material is coated such that the resulting coating is not thick enough to completely file the pores, i.e., a channel of desired width remains in the pore after the polymer is coated. The width of the channel will subsequently determine the width of the nanowire. Preferably, the etchable coating has a uniform thickness in order to produce nanowires of uniform thickness.

The porous material can be any nanoporous, mesoporous, or microporous material known in the art. Preferably, the porous material contains an ordered arrangement of pores and is not reactive with the metals or etchable material to be deposited. A particular class of porous materials for this purpose include the porous polymer membranes, such as track-etched polycarbonate (e.g., the Nuclepore® membranes). Other porous polymer compositions are described, for example, in U.S. Pat. No. 4,961,853, the contents of which are incorporated herein in their entirety. Porous polymer membranes are often more preferred as a sacrificial template since they are generally more readily etchable (e.g., by solvent, acid, or base) and/or pyrolyzable than metal oxide materials. The foregoing methodology can be particularly advantageous in producing an array of nanowires in which the nanowires are of uniform thickness, have a uniform distance between nanowires (i.e., uniform spacing), or have a uniform alignment, and/or other uniform characteristics.

In other embodiments, the nanowires can be produced by an electroless etching method, and particularly, a metal-assisted electroless etching method. See, for example, A. I. Hochbaum, et al., Nature, 451, 163-167 (Jan. 10, 2008). The technique involves the aqueous-phase galvanic displacement of a substrate material (e.g., silicon) by the reduction of metal ions (e.g., silver ions) on a substrate's surface. A particular characteristic of the electroless etching method is that it is capable of producing arrays of vertically aligned silicon nanowires that feature exceptionally rough surfaces. In other embodiments, one or more of any of the foregoing nanowire production methods are excluded from the method of the instant invention.

In another aspect, the invention is directed to arrays of nanowires, as described above, in which each nanowire is surrounded (i.e., covered) by a metal oxide shell (i.e., metal-(metal oxide) core-shell nanowires). In different embodiments, each nanowire is at least partially surrounded, or completely or substantially surrounded by the metal oxide shell. Generally, the metal oxide shell surrounds the nanowire along its length, while the nanowire is not covered by the metal oxide at the end (i.e., tip) of the nanowire directed away from a substrate on which the nanowires reside. In different embodiments, the nanowire tip may be substantially level with, or raised above, or be set below, an end of the metal oxide shell colinear with the nanowire.

At least a portion of the metal oxide shell is of a metal oxide composition. In some embodiments, a portion of the metal oxide shell is of a metal oxide composition while another portion of the shell is other than a metal oxide composition (e.g., a metallic, metal sulfide, metal selenide, metal phosphate, metal halide, organic polymer, or ionic liquid). Moreover, a bilayer shell may be employed in which an inner shell surrounding the nanowire has a metal oxide composition, as described above, and is surrounded by an outer shell of a different composition (e.g., as above) than the inner shell. One or more intermediate shell layers may or may not also be included.

The metal oxide can be an oxide composition of any one or more metals. The one or more metals of the oxide composition can be selected from, for example, the alkali metals (e.g., Li⁺, Na⁺, K⁺), alkaline earth metals (Me⁺, Ca²⁺, Sr²⁺, Ba²⁺), transition metals (as described above), main group metals (e.g., elements of Groups IIIA (boron group) to VIA (oxygen group), and specific examples described above), and the rare earth metals, such as the lanthanide metals (e.g., La, Ce, Nd, Eu). In particular embodiments, the metal oxide is, or includes, an oxide of a Group IVA metal (e.g., silicon oxide, germanium oxide, and/or tin oxide). In other particular embodiments, the metal oxide is, or includes, an oxide of a Group IIIA metal (e.g., boron oxide, aluminum oxide, gallium oxide, indium oxide, and/or thallium oxide). In other particular embodiments, the metal oxide is, or includes, an oxide of a Group VIA metal (e.g., SeO₂ or TeO₂). In yet other embodiments, one or more Group IIIA metals, metal oxides, or other compounds, and/or Group VIA metals, metal oxides, or other compounds, and/or Group IVA metals, metal oxides, or other Group IVA compositions are excluded from the metal oxide shell (or, alternatively, excluded from an inner shell or outer shell layer if a bilayer or multilayer shell system is used).

In particular embodiments, the metal oxide shell is, or includes, an oxide of one or more early transition metals, i.e., of Groups IIIB (scandium group), IVB (titanium group), and VB (vanadium group). Some examples of Group IIIB metal oxides include the scandium oxides (e.g., Sc₂O₃) and yttrium oxides (e.g., Y₂O₃). Some examples of Group IVB metal oxides include the titanium oxides (e.g., TiO₂, TiO, and/or Ti₂O₃), zirconium oxides (e.g., ZrO₂), and hafnium oxide (HfO₂). Some examples of Group VB metal oxides include the vanadium oxides (e.g., V₂O₅, V₂O₃, and/or VO), niobium oxides (e.g., Nb₂O₅, NbO₂, and/or NbO), and tantalum oxides (e.g., Ta₂O₅).

The metal oxide composition can be either stoichiometric, as indicated in the formulas above, or non-stoichiometric. A non-stoichiometric composition is indicated in a formula by the presence of fractional subscripts. For example, the generic formula MO (where M is a suitable metal, such as Ti, V, Zn, or alkaline earth metal) can mean the indicated formula in stoichiometric form, or alternatively, a non-stoichiometric formula of, for example, MO_{0.5}, MO_{0.6}, MO_{0.7}, MO_{0.8}, MO_{0.9}, MO_{1.1}, MO_{1.2}, MO_{1.3}, or MO_{1.4}, or ranges of the oxygen subscripts between any of these exemplary formulas, or between MO and any of these exemplary formulas. Similarly, the generic formula MO₂ (where M is a suitable metal, such as Ti, Zr, Hf, Nb, Mo, W, Mn, Ru, and Re) can mean the indicated formula in stoichiometric form, or alternatively, a non-stoichiometric formula of, for example, MO_{1.6}, MO_{1.7}, MO_{1.8}, MO_{1.9}, MO_{2.1}, MO_{2.2}, MO_{2.3}, or MO_{2.4}, or ranges of the oxygen subscripts between any of these exemplary formulas or between MO₂ and any of these exemplary formulas. Alternatively, the subscript of the metal may be non-stoichiometric, as in M_{0.7}O, M_{0.8}O, M_{0.9}O, M_{1.1}O, M_{1.2}O, M_{1.3}O, M_{1.4}O, M_{0.7}O₂, M_{0.8}O₂, M_{0.9}O₂, M_{1.1}O₂, M_{1.2}O₂, M_{1.3}O₂, and M_{1.4}O₂, or ranges of the metal subscripts between any of these exemplary formulas or between MO or MO₂ and any of these exemplary formulas. As herein considered for the metal oxide shell, any one or more of the foregoing compositions may be included, or alternatively, excluded, as metal oxide compositions.

The metal oxide composition can also be in one or more particular phases. For example, the stoichiometric or non-stoichiometric metal oxide composition can have an anatase, rutile, brookite, and/or amorphous structure.

The metal oxides described above may also be doped or undoped. If doped, the dopant can be any metal that suitably adjusts the properties of the nanowire array to function as an anode material for a lithium ion battery. Some examples of dopants include any of the alkali, alkaline earth, transition, main group, and rare earth metals described above. Some particular examples of doped metal oxide compositions include silicon-doped tin oxide, fluorine-doped tin oxide (FTO), indium-doped tin oxide (ITO), tungsten-doped tin oxide, silicon-doped aluminum oxide, phosphorus-doped silicon oxide, arsenic-doped silicon oxide, boron-doped silicon oxide, tungsten-doped silicon oxide or aluminum oxide, as well as rare earth-doped metal oxides, such as rare earth-doped tin oxide, aluminum oxide, silicon oxide, and/or titanium oxide.

In one embodiment, the metal oxide shells surrounding each of the nanowires are separated, i.e., there is a spacing between metal oxide shells. The spacing between metal oxide shells can be empty space (e.g., air, an inert gas, or a vacuum), or alternatively, a non-metal oxide composition that interconnects the metal oxide shells.

In another embodiment, the metal oxide shells surrounding each of the nanowires are connected with each other. In some embodiments, the metal oxide shells are connected at specific points or regions, while in other embodiments, the metal oxide shells are formed of a continuous matrix material that separates and fills in spaces between nanowires.

In the case of discrete metal oxide shells (i.e., tubes), the thickness (i.e., inner or outer diameter) of the shells is generally no more than about 1 micron (1 μm). In different embodiments, the thickness of the metal oxide shell can be, for example, precisely, at least, up to, or less than 1 μm, 900 nm, 800 nm, 700 nm, 600 nm, 550 nm, 500 nm, 450 nm, 400 nm, 350 nm, 300 nm, 250 nm, 200 nm, 150 nm, 100 nm, 50 nm, 40 nm, 30 nm, 20 nm, 10 nm, 5 nm, or 2.5 nm or a thickness within a range bounded by any two of the foregoing values.

In particular embodiments, the metal oxide shells are in the form of interconnected metal oxide nanotubes. Such nanotube array materials are particularly known for titanium dioxide. TiO₂ nanotubes have been prepared by several methods, including electrochemical oxidation (i.e., anodization), hydrothermal synthesis, and template-assisted synthesis. The anodization method typically produces highly ordered nanotube structures, as described in, for example, C. A. Grimes, J. Mater. Chem., 17, 1451-1457 (2007) and G. K. Mor, et al., “A review on highly ordered, vertically oriented TiO₂ nanotube arrays: Fabrication, material properties, and solar energy applications,” Grimes, Sol. Energy Mater. Sol. Cells, 2006, 90, 2011. The anodization process is also favored due to its general simplicity and high controllability. The anodization process generally involves anodizing titanium in an electrolytic solution containing water or a polar organic solvent (e.g., ethylene glycol, formamide, N-methylformamide, or dimethylsulfoxide) having dissolved therein a fluoride-containing electrolyte, such as HF, KF, NaF, NH₄F, or a tetraalkylammonium fluoride (e.g., Bu₄NF). The as-anodized amorphous TiO₂ nanotubes can be crystallized by heat-treating under an inert atmosphere, such as nitrogen (N₂). In other embodiments, ordered TiO₂ nanotubes can be produced by anodization of titanium in an ionic liquid electrolyte, as described in I. Paramasivam, et al., Electrochimica Acta, 54, pp. 643-648 (2008), the contents of which are incorporated herein by reference in their entirety.

The nanotubes in the metal oxide nanotube array can have any suitable outer diameter. For example, in different embodiments, the nanotubes may have an outer diameter of about, at least, up to, or less than 25 nm, 30 nm, 35 nm, 40 nm, 45 nm, 50 nm, 60 nm, 70 nm, 80 nm, 90 nm, 100 nm, 120 nm, 150 nm, 200 nm, 250 nm, 300 nm, 350 nm, 400 nm, 450 nm, 500 nm, 550 nm, 600 nm, 650 nm, 700 nm, 750 nm, 800 nm, or an outer diameter within a range bounded by any two of these exemplary values.

The nanotubes in the metal oxide nanotube array can also have any suitable pore (i.e., inner) diameter. For example, in different embodiments, the nanotubes may have a pore diameter of about, at least, up to, or less than 2 nm, 5 nm, 10 nm, 15 nm, 20 nm, 25 nm, 30 nm, 35 nm, 40 nm, 45 nm, 50 nm, 60 nm, 70 nm, 80 nm, 90 nm, 100 nm, 120 nm, 150 nm, 200 nm, 250 nm, 300 nm, 350 nm, 400 nm, 450 nm, 500 nm, 550 nm, 600 nm, 650 nm, 700 nm, or 750 nm, or a pore diameter within a range bounded by any two of these exemplary values. In particular embodiments, at least a portion (or substantially all, or all) of the nanotubes are mesoporous (i.e., have pore widths within 2-50 nm).

The nanotubes in the metal oxide nanotube array can possess any of the foregoing pore diameters in combination with any of the above outer diameters, wherein it is understood that the pore diameter is less than the outer diameter, and the difference in pore diameter and outer diameter generally corresponds to the wall thickness. In different embodiments, the nanotubes may have a wall thickness of about, at least, up to, or less than 1 nm, 2 nm, 3 nm, 4 nm, 5 nm, 10 nm, 12 nm, 15 nm, 18 nm, 20 nm, 25 nm, 30 nm, 35 nm, 40 nm, 45 nm, 50 nm, 60 nm, 70 nm, 80 nm, 90 nm, or 100 nm, or a wall thickness within a range bounded by any two of these exemplary values.

The nanotubes in the metal oxide nanotube array can also have any suitable length. A desired length of the nanotube can generally be attained by growing the nanotube for a suitable period of time at a particular growth rate. In different embodiments, the nanotubes may have a length of about, at least, up to, or less than, for example, 50 nm, 100 nm, 150 nm, 200 nm, 250 nm, 300 nm, 350 nm, 400 nm, 500 nm, 600 nm, 700 nm, 800 nm, 900 nm, 1 μm, 2 μm, 5 μm, 10 μm, 15 μm, 20 μm, 25 μm, 30 μm, 40 μm, 50 μm, 60 μm, 70 μm, 80 μm, 90 μm, 100 μm, or 120 μm, or a length within a range bounded by any two of these exemplary values. The corresponding length-to-diameter aspect ratio (i.e., “aspect ratio”) can be, for example, at least about 2, 5, 10, 20, 30, 40, 50, 100, 150, 200, 250, 500, 600, 700, 800, 900, 1000, or an aspect ratio within a range bounded by any two of these exemplary values. In some embodiments, the nanotube length is equivalent to the thickness of the porous metal oxide substrate.

In one embodiment, the metal oxide shell is in contact with the nanowire over at least a portion of the inner surface of the metal oxide shell facing (i.e., covering or surrounding) the nanowire. For example, the metal oxide shell may be in contact with the nanowire at specific points, or along one or more sides, of the surface of the metal oxide shell facing the nanowire. Alternatively, the metal oxide shell is in contact with the nanowire over the entire surface of the metal oxide shell facing the nanowire.

In another embodiment, a space separates the nanowire and metal oxide shell such that the nanowire and metal oxide shell are not in contact. For a nanowire having a uniform thickness through its length, the spacing between the nanowire and metal oxide shell is generally uniform. The spacing between the nanowire and metal oxide shell can be any suitable spacing, such as, for example, a spacing of about, at least, up to, or less than 1 nm, 2 nm, 5 nm, 10 nm, 15 nm, 20 nm, 25 nm, 30 nm, 35 nm, 40 nm, 45 nm, 50 nm, 60 nm, 70 nm, 80 nm, 90 nm, 100 nm, 120 nm, 140 nm, 160 nm, 180 nm, 200 nm, 220 nm, 240 nm, 260 nm, 280 nm, 300 nm, 350 nm, 400 nm, 450 nm, or 500 nm, or a spacing within a range bounded by any two of these exemplary values. In other embodiments, the spacing is selected based on the thickness of the nanowire, e.g., about, at least, up to, or less than 5, 10, 20, 30, 40, 50, 60, 70, 80, 90, or 100 percent of the nanowire thickness.

Any method for producing a nanowire-metal oxide shell composition is considered herein. In one set of embodiments, a metal oxide is deposited onto an array of nanowires. The metal oxide can be deposited as a coating that, at least to some degree, outlines the contours of the nanowires. Alternatively, the metal oxide can be deposited as a coating that substantially or completely covers the nanowires and fills in the spacing between nanowires. Some of the methods that can be used for depositing a metal oxide onto a nanowire array include atomic layer vacuum deposition methods (e.g., by use of TiCl₄ and water as precursors for a TiO₂ coating), sol gel coating methods (e.g., by hydrolysis of a metal alkoxide or metal halide precursor), sputtering techniques (e.g., ion beam, RF, and reactive sputtering), pulsed laser deposition (PLD), molecular beam epitaxy (MBE), chemical vapor deposition (CVD), metal-organic chemical vapor deposition (MOCVD), plasma-enhanced chemical vapor deposition (PECVD), cathodic arc deposition, and deposition of a precursor metal (e.g., Ti, Al, Si, Ge, Cu, or Ni) onto the nanowires followed by oxidation of the precursor metal to the corresponding metal oxide. In other embodiments, one or more of any of the foregoing deposition methods are excluded from the method of the instant invention.

In a particular set of embodiments, the nanowires are grown into pre-fabricated shells of a metal oxide composition. The prefabricated shells can be an array of separated shells, interconnected shells, or pores in a porous metal oxide material. In particular embodiments, the porous metal oxide material is nanoporous anodic aluminum oxide (AAO) or electrochemically-etched alumina membranes. Nanowires can be grown into a porous metal oxide material by, for example, electrochemical deposition (i.e., electrodeposition) of one or more metals (at least one of which is a Group IV metal, as described above) into the pores. The one or more metals being electrodeposited into the pores are the one or more metals to be incorporated into the nanowires. In a preferred embodiment, the electrodeposition of a metal into the pores is preceded by affixing an electrically conductive substrate on a side of the porous substrate cross-sectional (i.e., approximately or substantially perpendicular) to the width of the pores. The conductive substrate can be, for example, a metal or conductive polymer. Any suitable method for depositing a layer of conductive material is considered herein. For example, in some embodiments, ion sputtering, metal evaporation, an electroless deposition process, or physical attachment is used for depositing a conductive metal substrate. The conductive substrate permits an electrodeposition process to be initiated (i.e., by functioning as an electrode). The electrodeposition process can be any such process of the art that will not damage or adversely affect the metal oxide precursor material.

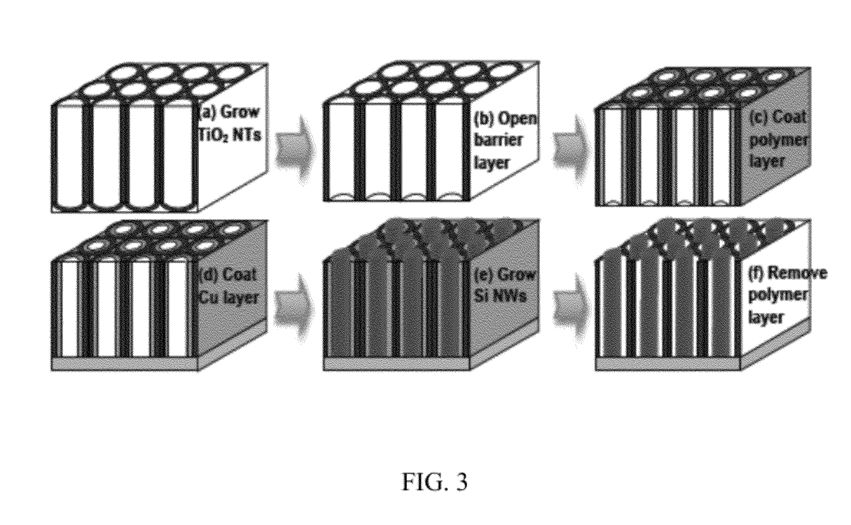

If a space is to be included between the nanowire and metal oxide shell, a special method, such as further described below and as shown in FIG. 3, can be employed to prepare such a nanowire-metal oxide composition. In particular embodiments, after growing a metal oxide nanoporous template (i.e., step (a) in FIG. 3) and opening the tube ends (i.e., step (b) in FIG. 3), the method involves depositing a coating of an etchable material, as described above (e.g., an etchable polymer) onto the inner walls of pores of a porous metal oxide material (step (c) in FIG. 3). The tube ends can be opened (i.e., removed) by, for example, etching the ends with a dilute solution of hydrofluoric and/or sulfuric acid. After coating the inner walls of the pores, cross-sectional attachment of an electrically conductive substrate, such as Cu or Au (as shown in step (d) of FIG. 3) is performed in preparation for growing metal nanowires in the coated nanopores. Significantly, a different order in the steps may be preferred under different circumstances. For example, in some embodiments, it may be preferred to cut the tube ends after deposition of the polymer coating.

After the polymer coating is deposited onto the inner walls of the pores of the metal oxide substrate, one or more metals, at least one of which is a Group IV metal, is deposited into the produced channels, thus resulting in nanowires having widths equivalent to the widths of the channels, produced as described above and as shown in step (e) of FIG. 3. The metals can be deposited by any of the techniques described above for growing nanowires in pores.

Lastly, as shown in step (f) of FIG. 3, to produce a space between the metal oxide and nanowires, the polymer coating is removed by, for example, etching the polymer with a solvent, or vaporizing or pyrolyzing the polymer by subjecting it to an appropriately elevated temperature, typically under an inert atmosphere. If further desired, the open ends of the pores can be sealed by attaching a sealing layer thereon. Furthermore, if desired, the substrate attached to one end of the pores may be removed. In other embodiments, the spaces may be filled with a gaseous or liquid material, such as an inert gas, a solvent, or a battery electrolyte material. In yet other embodiments, the spaces may be filled with a solid metal or metal alloy, different in composition from the nanowire composition, in order to produce a core-shell nanowire array, as described above, embedded in a metal oxide matrix. Such a process can advantageously produce core-shell nanowires with uniform core and shell thicknesses.

In the embodiments described above, the metal oxide material is not removed, and thus, remains as a matrix material separating the nanowires. In other embodiments, nanowires can be grown into a porous metal oxide or other porous material, as described above, and the metal oxide or other porous material subsequently removed to leave only the nanowires. The nanowires can be any of the single-layer or core-shell nanowires that have been grown into a porous material.

In another embodiment, the invention is directed to arrays of nanowires, as described above, in which the nanowires are embedded within periodic nanochannels of a metal oxide-ionic liquid ordered host material. In particular embodiments, the nanowires are uniformly separated and aligned within the metal oxide-ionic liquid ordered host material. The metal oxide-ionic liquid ordered host material can be, for example, the mesoporous (imidazolium-based ionic liquid)-(silica) ordered host materials described in B. Lee, et al., Chem. Commun., pp. 240-241 (2004), the contents of which, including all supplemental materials, are incorporated herein in their entirety. Such ordered host materials generally possess the characteristic that the nanochannels therein are uniformly separated, or alternatively, spaced with respect to each other in an ordered (i.e., periodic or patterned) arrangement. In a periodic arrangement, it is possible that the separation between nanochannels varies, but the variation is ordered (i.e., patterned). For example, the nanochannels can be in a hexagonal, hexagonal close packed, lamellar, or cubic arrangement. Furthermore, in some embodiments, the nanochannels are non-intersecting, while in other embodiments, the nanochannels are intersecting, e.g., a gyroidal arrangement of intersecting nanochannels having an overall cubic symmetry. The nanochannels can have any of the diameters given above for the nanowires. In particular embodiments, the nanochannels have a minimum diameter of 1, 2, 3, 4, 5, 10, 12, 15, 20, 30, 40, or 50 nm, and/or a maximum diameter of 60 nm, 70 nm, 80 nm, 90 nm, 100 nm, 120 nm, 150 nm, 180 nm, 200 nm, 250 nm, or 300 nm, or alternatively, a range bounded by two of the minimum diameters or two of the maximum diameters. In addition, the separation between nanochannels can be any of the values given above for nanochannel diameters. The ordered host material can also have any suitable pore volume, e.g., about, at least, up to, or less than 0.1, 0.2, 0.3, 0.4, 0.5, 0.6, 0.7, 0.8, or 0.9, or within a range bounded by any two of these values.

Any suitable method for incorporating (i.e., embedding) metal nanowires into the periodic nanochannels of the metal oxide-ionic liquid ordered host material is considered herein. In particular embodiments, the nanowires are incorporated into the host material by electrodepositing one or more metals into the nanochannels of the host materials, by methods analogous to those described above for incorporating nanowires into a porous metal oxide or polymeric material.

The ordered host material is any such porous material that contains at least one ionic liquid compound or polymer and at least one metal oxide compound or polymer, such that the ionic liquid and metal oxide are intermingled to produce an ordered arrangement of pores in the material. The ordered nature of the metal oxide-ionic liquid composition generally results by supramolecular assembly of the components when the components are combined and reacted.

The ionic liquids of the metal oxide-ionic liquid compositions are generally in liquid form (i.e., fluids) at or below 100° C., more preferably at or below 50° C., and even more preferably, at or below room temperature (i.e., at or less than about 15, 20, 25, or 30° C.). In other embodiments, the ionic liquids are in liquid form at or below 0° C., −5° C., −10° C., −20° C., or −30° C. Preferably, the ionic liquid possesses a melting point that is at or below any of the temperatures given above. Although the invention primarily contemplates ionic liquids that are naturally fluids at or below room temperature, the invention also contemplates ionic liquids that are solid or semi-solid at about room temperature or above, but which can be rendered liquids at a higher temperature by the application of heat. In some embodiments, a solid ionic compound or polymer not ordinarily considered to be an ionic liquid may be used in place of an ionic liquid if such a compound or polymer provides the same function as an ionic liquid, i.e., of functioning as an ordering template for the metal oxide component.

In particular embodiments, the ionic liquid can be one or more ionic liquids selected from, for example, the imidazolium, pyrrolidinium, pyridinium, piperidinium, ammonium, phosphonium, and/or sulfonium types of ionic liquids. Generally, the nitrogen-containing ionic liquids contain one or more N-hydrocarbyl groups, e.g., as in the N-alkyl or N,N-dialkylimidazolium, N,N-dialkylpyrrolidinium, or N-alkylpyridinium ionic liquids. Similarly, the phosphonium and sulfonium types of ionic liquids generally contain P-alkyl or S-alkyl groups, respectively. Heteroatoms that do not bear a hydrocarbyl group generally are bound to a hydrogen atom. The hydrocarbyl (i.e., hydrocarbon) group can contain, for example, at least 1, 2, 3, 4, 5, or 6 carbon atoms, and up to, for example, 7, 8, 9, 10, 11, 12, 13, 14, 15, 16, 17, or 18 carbon atoms. In some embodiments, the cationic and/or anionic portions of the ionic liquid are structurally symmetrical (e.g., as in N,N-dimethylimidazolium, N,N-diethylimidazolium, N,N-di(n-propyl)imidazolium, N,N-di(isopropyl)imidazolium, N,N-di(n-butyl)imidazolium, N,N-di(n-hexyl)imidazolium, N,N-di(n-octyl)imidazolium, N,N-di(n-dodecyl)imidazolium, N,N-di(n-hexadecyl)imidazolium based ionic liquids, as well as analogous pyrrolidinium and piperidinium ionic liquids). In other embodiments, the cationic and/or anionic portions of the ionic liquid are structurally asymmetrical (e.g., as in N-methyl-N-ethylimidazolium, N-methyl-N-(n-propyl)imidazolium, N-methyl-N-(n-butyl)imidazolium, N-ethyl-N-(n-butyl)imidazolium, N-methyl-N-(n-hexyl)imidazolium, N-methyl-N-(n-octyl)imidazolium, N-methyl-N-(n-dodecyl)imidazolium, N-methyl-N-(n-hexadecyl)imidazolium, N-methyl-N-(n-hexadecyl)imidazolium, N-butyl-N-(n-dodecyl)imidazolium, and N-isopropyl-N-(n-hexadecyl)imidazolium based ionic liquids). For any of the foregoing imidazolium groups, the 2-position (i.e., carbon between the two ring nitrogen atoms) can be occupied by either a hydrogen atom or a hydrocarbyl group, such as methyl. The anion of the ionic liquid can be, for example, a halide, hydroxide, alkoxide, sulfate, sulfite, bisulfate, bisulfite, nitrate, nitrate, carboxylate (e.g., acetate), dicyanamide, or a bis(perfluoroalkylsulfonyl)imide (e.g., bis-(perfluoromethyl)sulfonylimide, i.e., Tf₂N⁻, or N[SO₂CF₂CF₃]₂ , i.e., “BETI⁻”).

The metal oxide component of the ordered host material can be any of the metal oxide materials described above. In particular embodiments, the metal oxide component is, or includes, silicon oxide (e.g., silica). For any metal oxide incorporated into the ordered host material, the metal oxide may or may not include an organic component, thereby rendering the metal oxide component a hybrid organic-inorganic composition. The organic component is generally in the form of organic linking groups (i.e., organic linkers or “bridges”) that link metal oxide units. The linkers can be, for example, any of the hydrocarbon linkers known in the art, such as methylene (—CH₂—), dimethylene (—CH₂CH₂—), trimethylene (—CH₂CH₂CH₂—), vinylene (—CH═CH—), phenylene, and the like. In any of the foregoing linkers, one or more hydrogen atoms may or may not be substituted by a hydrocarbyl group.

Any method for constructing such metal oxide-ionic liquid ordered materials is considered herein. In particular embodiments, the ordered host material is synthesized by combining one or more ionic liquids in a solvent (e.g., water, alcohol, or mixture thereof) along with one or more metal alkoxides that function as metal oxide precursors. Generally, a base or acid compound is included to encourage hydrolysis of the metal alkoxides. In some embodiments, the crude product precipitates from an aqueous-based solution. Excess amounts of ionic liquid can often be removed by extraction of the crude product with a suitable solvent, such as an alcohol (e.g., ethanol).

In particular embodiments, the precursor metal alkoxide is a silicon alkoxide, which, upon hydrolysis, produces a silica-containing host material. Some examples of silicon alkoxide compounds include the orthosilicates, i.e., Si(OR)₄, (e.g., tetramethylorthosilicate (TMOS) and tetraethylorthosilicate (TEOS)), the alkyltrialkoxysilanes (i.e., RSi(OR)₃), the dialkyldialkoxysilanes (i.e., R₂Si(OR)₂), the disiloxanes (i.e., R¹₃Si—O—SiR¹₃), trisiloxanes (i.e., R¹₃Si—O—SiR¹₂—O—SiR¹₃), higher siloxanes (e.g., tetrasiloxanes, pentasiloxanes, hexasiloxanes, and polysiloxanes), cyclotrisiloxanes, cyclotetrasiloxanes, cyclopentasiloxanes, cyclohexasiloxanes, and the silsesquioxanes, wherein R independently represents a hydrocarbon group, and at least two of the R¹ groups for a siloxane molecule are, independently, alkoxide groups.

In another aspect, the invention is directed to a lithium ion battery that contains, in an anode therein, any of the nanowire compositions described above. The lithium ion battery can have any of the architectures and designs of lithium ion batteries known in the art. Some types of lithium ion batteries particularly considered include the liquid electrolyte lithium ion battery, lithium ion polymer battery, and lithium air battery. As known in the art, some common features of lithium ion batteries include a negative electrode (often referred to as the anode), positive electrode (often referred to as a cathode), and a lithium-conducting electrolyte (e.g., an organic solvent, such as an ether or organic carbonate, or a lithium-conducting gel or solid) that transports lithium ions between the two electrodes during charging and discharging.

Numerous materials may be used as the positive or negative electrode. The choice of electrode material depends to a large extent on the construction of the lithium ion battery (e.g., compatibility of the electrode material with other components of the battery), desired performance characteristics (e.g., energy and power densities), and application. Some examples of anode materials include graphite (i.e., intercalated lithium graphite), lithium metal, lithium alloy (e.g., lithium-aluminum or lithium-indium), lithium-containing polyatomic anion transition metal compounds (e.g., LiTi₂(PO₄)₃), and lithium-containing transition metal oxides, particularly of titanium or vanadium, such as Li₄Ti₅O₁₂. Some examples of cathode materials include layered oxide materials (e.g., lithium-containing transition metal oxides, such as LiCoO₂, LiNiO₂, LiMnO₂, and LiNiₓMn_{y}Co_{z}O₂, wherein x, y, and z sum to 1, and at least one, two, or all of x, y, and z are non-zero), lithium-containing polyatomic anion transition metal compounds (e.g., LiFePO₄ and Li₂FePO₄F), and lithium-containing spinel oxides (e.g., Li₂Mn₂O₄). Typically, the electrode materials are configured as a layer on a base metal, such as aluminum, carbon, or stainless steel. If desired or found necessary, the electrode materials can also include an electron conduction additive, ion conduction additive, or both. Some examples of electron conduction additives include conductive carbon, metal powder, and conductive polymers. Some examples of ion conduction additives include lithium ion conductive crystals or glass-ceramics. In particular embodiments, an electron conduction and/or ion conduction additive is excluded.

The theoretical charge-discharge capacity (i.e., theoretical capacity) provided by the nanowire compositions of the instant invention are generally greater than 372 mAh/g, the theoretical capacity of current graphite anodes. In different embodiments, the theoretical capacity provided by the instant nanowire compositions is about, at least, or up to 400, 500, 600, 700, 800, 900, 1000, 1100, 1200, 1300, 1400, 1500, 1600, 1700, 1800, 1900, 2000, 2100, 2200, 2300, 2400, 2500, 2600, 2700, 2800, 2900, 3000, 3100, 3200, 3300, 3400, 3500, 3600, 3700, 3800, 3900, or 4000 mAh/g, or a theoretical capacity within a range bounded by any two of the foregoing exemplary values. The theoretical capacity is dependent on numerous factors, including the architecture and design of the nanowire array, the arrangement of the nanowires, composition of the nanowires, thickness of the nanowires, uniformity of the nanowires, concentration of the nanowires per unit area, as well as design and architecture of the anode and lithium battery being used. For the case of core-shell nanowire systems, the theoretical capacity and other properties can also depend on the compositions and thicknesses of the core and shell. For example, for a core-shell nanowire in which the core is about 30 nm thick and made of copper, and the shell is 100 nm thick and made of silicon, the theoretical capacity can be at least about 3000 mAh/g.

Preferably, the core electrical resistivity of the nanowires described herein is less than .01 (i.e., 1×10⁻²) ohm-cm. In particular embodiments, the core electrical resistivity of the nanowires is about or less than 5×10⁻³, 1×10⁻³, 5×10⁻⁴, 1×10⁻⁴, 5×10⁻⁵, 1×10⁻⁵, 5×10⁻⁶, 1×10⁻⁶, 5×10⁻⁷, or 1×10⁻⁷ ohm-cm, or a core electrical resistivity within a range bounded by any two of these exemplary values. A lower electrical resistivity is generally desired, since a lower electrical resistivity corresponds to an improved electron transport efficiency.

Preferably, the nanowires also exhibit a suitable or improved durability (e.g., as compared to graphite and/or aluminum). The durability is evidenced by the core toughness. Depending on the composition, the core fracture toughness of the nanowires can be, for example, at least 5, 10, 15, 20, 25, 30, 35, 40, 45, 50, 55, or 60 MPa·m^{1/2}.

Examples have been set forth below for the purpose of illustration and to describe certain specific embodiments of the invention. However, the scope of this invention is not to be in any way limited by the examples set forth herein.

### EXAMPLE 1

### Synthesis of a Cu—Si Core-Shell Nanowire Array

A Cu—Si core-shell nanowire array was fabricated according to the general schematic shown in FIG. 1 (i.e., by template-aided electrodeposition). A nanoporous polycarbonate (PC) membrane was used as a template. The template had a nominal pore size of 100 nm, a nominal pore density of 4×10⁸/cm², and a nominal membrane thickness of 6 μm. Referring to step (a) of FIG. 1, a thin gold film of 50-100 nm thickness (indicated as a bottom layer) was first sputtered on a side (i.e., backside) of the PC membrane using metal evaporation. This gold layer was too thin to cover the pores. Then, a thicker copper backplate (−20 μm) was grown on top of the gold film via electrodeposition. The deposition was conducted using a CHI model 660A potentiostat/galvanostat (CH Instruments, Austin, Tex.) in a three-electrode configuration with a Ag/AgCl reference electrode. The electrolyte was an aqueous solution containing 0.6 M CuSO₄ and 1.0 M H₂SO₄. The applied potential was −0.4 V and the deposition time was two hours. The copper backplate effectively sealed the bottoms of the nanopores in order for it to function as an electrode for electrodeposition of a metal (e.g., copper) into template pores to produce metal (e.g., copper) nanowires therein. In addition, the copper backplate provided a strong mechanical support and functioned as a current collector for the nanowires.

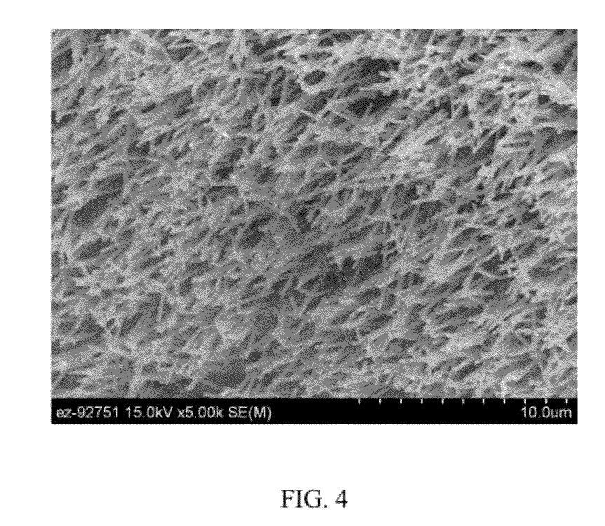

As illustrated in step (b) of FIG. 1, copper nanowires were grown inside the nanopores using a similar electrodeposition process as described above but a short deposition time (−10 minutes). The PC membrane was then etched off in CH₂Cl₂, as illustrated in step (c) of FIG. 1. FIG. 4 is a micrograph of the copper nanowire array produced via the above process. The nanowires were observed to be relatively uniform in size and with fairly good alignment. The wire diameter was observed to vary from about 150 to 200 nm, much larger than the pore size (−100 nm) of the PC membrane. This effect was probably caused by the high flexibility of polycarbonate, which permitted pore expansion during the copper wire growth. The wire length was in a range of 3-6 μm.

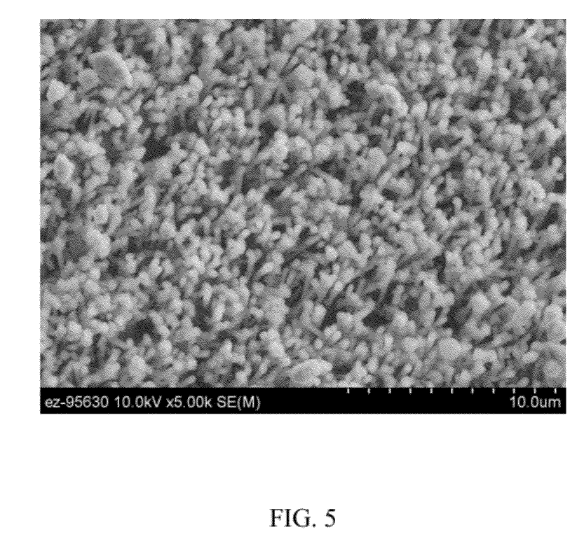

As illustrated in step (d) of FIG. 1, a silicon layer was then deposited on the copper nanowires via plasma-enhanced chemical vapor deposition (PECVD). The process was performed using silane (SiH₄) as the feedstock at a 15 cc/min constant supply conducted with a 40-watt plasma at 250° C. for 7 hours and 15 minutes. The formed Cu—Si core-shell nanowire array is shown in FIG. 5. FIG. 5 indicates that all copper nanowires are substantially covered with a silicon coating. Based on the wire diameter of 300-350 nm, the silicon layer thickness is estimated to be 50-100 nm.

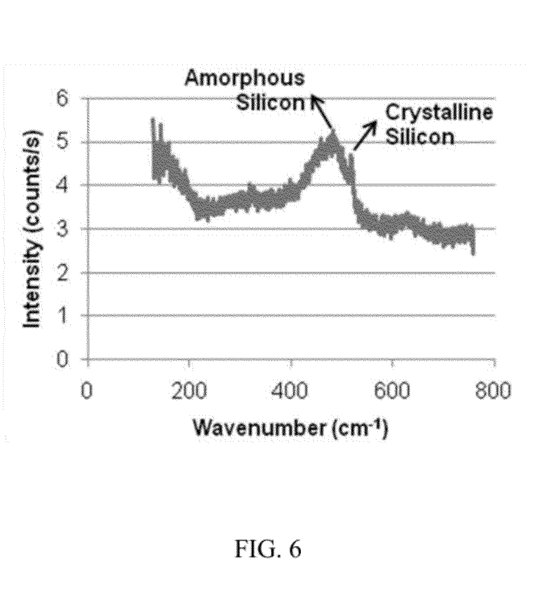

As shown in FIG. 6, Raman spectroscopy analysis of the Cu—Si core-shell nanowire array indicates that the silicon shells are primarily in the amorphous phase. The amorphous phase is preferred when using the nanowire array in an anode because amorphous silicon tends to expand isotropically upon Li-ion insertion. This expansion should provide superior cycling performance compared to crystalline silicon.

### EXAMPLE 2

### Electrochemical Evaluation of the Cu—Si Core-Shell Nanowire Array as an Anode Material for Lithium-Ion Batteries

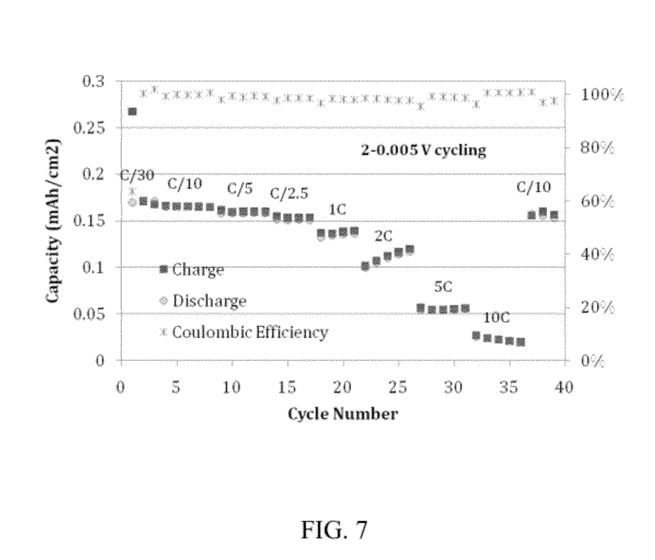

Two-electrode coin-type half-cells were assembled for the Cu—Si core-shell nanowire array, produced according to Example 1, using lithium metal foil as the counter/reference electrode with a polypropylene membrane separator. The electrolyte solutions contained 1.2 M LiPF₆ in a 1:2 mixture (by weight percent) of ethylene carbonate (EC) and dimethylcarbonate (DMC). Cells were assembled in glove boxes filled with pure argon. Galvanostatic charge—discharge cycling was performed using a multichannel battery tester from Maccor Inc., model 4000. They were tested in a potential range of 2.0-0.005 V using a constant current charge-discharge protocol at various rates from C/30 to 10 C. The initial half-cell testing results are described below and shown in FIG. 7.

The capacity of the Cu—Si core-shell nanowire array was observed to be approximately 1000 mAh/g at a charge/discharge rate of C/10 (converted from the measured unit area capacity), 3× of the theoretical capacity of a conventional graphite anode. Significantly, the capacity can be further increased (e.g., up to 3000 mAh/g) by depositing a thicker silicon layer or using a thinner copper core.

Significantly, the Cu—Si core-shell nanowire array produced herein demonstrated 95% capacity retention after 39 cycles at various charge-discharge rates C/30-10 C, as shown in FIG. 7. SEM examination showed no wire breakage or core-shell delamination after the 39 deep charge-discharge cycles. Without being bound by any theory, it is believed that this surprisingly superior performance is likely attributed to (1) the amorphous silicon shell that does not experience lithiation-induced silicon amorphization and (2) the copper core that avoids the peak radial stress at a silicon wire center if no core.

The Cu—Si core-shell nanowire array produced herein also exhibited an insignificant capacity drop for a higher charge/discharge rate up to 1 C. Other Si nanowires-based anode materials in the literature generally exhibit a substantially greater capacity drop when the cycling rate is increased. Without being bound by any theory, it is believed that this surprisingly superior performance is likely attributed to the highly conductive copper core, which permits a faster charge/discharge characteristic.

The Cu—Si core-shell nanowire array produced herein also exhibited a high Coulombic efficiency. Surprisingly, nearly 100% efficiency was achieved after the first cycle, and this was maintained through the 39-cycle test. It is believed that the 63% first cycle efficiency was largely due to SiOₓ formed on the silicon surface; thus, it is further believed that the efficiency can be improved by etching off the oxides before battery assembly.

While there have been shown and described what are at present considered the preferred embodiments of the invention, those skilled in the art may make various changes and modifications which remain within the scope of the invention defined by the appended claims.

What is claimed is:

1. An array of nanowires, wherein said nanowires are comprised of a transition metal core surrounded by a shell comprised of at least one Group IV metal selected from silicon, germanium, and tin.

2. The array of claim 1, wherein said nanowires possess uniform core and shell thicknesses.

3. The array of claim 1, wherein said transition metal core is comprised of at least one transition metal selected from Groups VIIIB, IXB, XB, IB, and IIB of the Periodic Table of the Elements.

4. The array of claim 1, wherein said transition metal core is comprised of at least one transition metal selected from Group IB of the Periodic Table of the Elements.

5. The array of claim 1, wherein said transition metal core is comprised of copper.

6. The array of claim 1, wherein said transition metal core is comprised of copper and said shell is comprised of silicon.

7. The array of claim 1, wherein said nanowires possess a thickness of up to 500 nm.

8. The array of claim 1, wherein said shell and transition metal core independently have thicknesses up to 300 nm.

9. The array of claim 1, wherein said shell and transition metal core independently have thicknesses up to 200 nm.

10. An array of nanowires, wherein said nanowires are comprised of at least one Group IV metal selected from silicon, germanium, and tin, wherein each nanowire is surrounded by a metal oxide shell, and wherein a space separates the nanowire and metal oxide shell in order to prevent said nanowire from contacting said metal oxide shell.

11. The array of claim 10, wherein said metal oxide shell comprises an oxide of a transition or main group metal.

12. The array of claim 10, wherein said metal oxide shell comprises an oxide of a transition metal.

13. The array of claim 12, wherein said transition metal is an early transition metal selected from Groups IIIB, IVB, and VB of the Periodic Table of the Elements.

14. The array of claim 12, wherein said metal oxide comprises titanium oxide.

15. The array of claim 10, wherein said nanowire has a diameter of up to 400 nm.

16. The array of claim 10, wherein said nanowire has a diameter of up to 200 nm.

17. The array of claim 10, wherein said nanowire has a diameter of up to 50 nm.

18. The array of claim 10, wherein said nanowire has a diameter of up to 20 nm.

19. An array of nanowires wherein said nanowires are comprised of at least one Group IV metal selected from silicon, germanium, and tin, and wherein said nanowires are embedded within periodic nanochannels of a metal oxide-ionic liquid ordered host material.

20. The composite material of claim 19, wherein said metal oxide comprises an oxide of a transition or main group metal.

21. The composite material of claim 19, wherein said metal oxide comprises a silicon oxide.

22. The composite material of claim 19, wherein said nanowires have a diameter of up to 10 nm.

23. The composite material of claim 19, wherein said nanowires have a diameter of up to 5 nm.

24. The composite material of claim 19, wherein said ionic liquid is a N,N-dialkylimidazolium ionic liquid.

25. A lithium ion battery containing an anode therein which is comprised of the nanowire array of claim 1.

26. A lithium ion battery containing an anode therein which is comprised of the nanowire array of claim 10.

27. A lithium ion battery containing an anode therein which is comprised of the nanowire array of claim 19.

28. A method for producing the array of nanowires of claim 1, the method comprising:
(i) depositing a transition metal into channels of a nanoporous template;
(ii) removing said template to produce exposed transition metal nanowires; and
(iii) depositing a metal comprised of at least one Group IV metal selected from silicon, germanium, and tin, onto said transition metal nanowires to produce an array of (transition metal core)-(Group IV metal shell) nanowires.

29. The method of claim 28, wherein said transition metal core and Group IV metal shell have thicknesses independently selected from a thickness of up to 200 nm.

30. The method of claim 28, wherein said transition metal core and Group IV metal shell have thicknesses independently selected from a thickness of up to 100 nm.

31. A method for producing the array of nanowires of claim 1, the method comprising:
(i) depositing a coating of an etchable material into pores of a porous substrate provided that a nanochannel having a width remains in each coated pore;
(ii) depositing a transition metal into said nanochannels to produce transition metal nanowires of said width;
(iii) removing said coating of etchable material to provide a spacing between each transition metal nanowire and inner walls of said pores of said porous substrate; and
(iv) depositing a metal comprised of at least one Group IV metal selected from silicon, germanium, and tin, into said spacings to produce an array of (transition metal core)-(Group IV metal shell) nanowires.

32. The method of claim 31, wherein said porous substrate is an etchable substrate.

33. The method of claim 32, wherein said etchable substrate is removed to produce an array of (transition metal core)-(Group IV metal shell) nanowires with empty space between the nanowires.

34. The method of claim 31, wherein said transition metal core and Group IV metal shell have thicknesses independently selected from a thickness of up to 300 nm.

35. The method of claim 31, wherein said transition metal core and Group IV metal shell have thicknesses independently selected from a thickness of up to 200 nm.

36. A method for producing the array of nanowires of claim 10, the method comprising:
(i) depositing a coating of an etchable material into pores of a porous metal oxide substrate provided that a nanochannel having a width remains in each coated pore;
(ii) depositing a metal comprised of at least one Group IV metal selected from silicon, germanium, and tin into said nanochannels to produce Group IV metal nanowires of said width; and
(iii) removing said coating of etchable material to provide a spacing between each Group IV metal nanowire and inner walls of said pores of said porous metal oxide substrate.

37. The method of claim 36, wherein said pores are up to 500 nm in thickness.

38. The method of claim 37, wherein said metal nanowires are up to 400 nm in thickness.

39. A method for producing the array of nanowires of claim 19, the method comprising depositing a metal comprised of at least one Group IV metal selected from silicon, germanium, and tin, into periodic nanochannels of a metal oxide-ionic liquid ordered host material.

40. The method of claim 39, wherein said metal oxide comprises a silicon oxide.

41. The method of claim 39, wherein said ionic liquid is a N,N-dialkylimidazolium ionic liquid.
